(19) United States
(12) Patent Application Publication
(10) Pub. No.: US 2006/0231224 A1
(43) Pub. Date: Oct. 19, 2006

(54) Composite paper sheet material and method for production thereof

(76) Inventors: Mauro Gelli, Lucca (IT); Giovanni Nencioni, Pisa (IT)

Correspondence Address: BREINER & BREINER, L.L.C., P.O. BOX 19290, ALEXANDRIA, VA, 22320-0290, US

(21) Appl. No.: 10/568,535

(22) PCT Filed: Sep. 8, 2004
(86) PCT No.: PCT/IT04/00483

§ 371 Date: Feb. 17, 2006

(30) Foreign Application Priority Data
Sep. 12, 2003 (IT) FI2003A000239

(51) Int. Cl. B32B 29/06

(52) U.S. Cl. 162/124; 162/117; 156/60; 156/209; 428/537.5; 162/123

(57) ABSTRACT

The paper sheet material comprises at least a first ply (V1) and a second ply (V2), coupled together by a glue. The first ply has a first embossing according to lines inclined with respect to a first longitudinal edge of the material, and the second ply is printed with a decorative pattern. The decorative motif (M) has shading simulating a relief three-dimensional design.

### TECHNICAL FIELD

The present invention relates to a sheet of composite paper material, in particular to a sheet constituted by at least two plies and preferably by at least three plies of tissue paper.

The invention also relates to a method or process to produce a material of this type.

### STATE OF THE ART

In the production of disposable products based on tissue paper, in particular napkins, rolls of toilet paper, rolls of kitchen towels and the like, there is a tendency to produce increasingly complex products with better and better-technical-functional and aesthetic characteristics.

WO-A-03043812 describes a paper handkerchief constituted by three layers superimposed on and glued to each other. The two outer layers are embossed with a pattern constituted by straight lines inclined with respect to the edge of the napkin and orthogonal with one another. An inner ply printed with a decorative pattern is interposed between the two outer plies. The outer plies are glued to the inner ply by a colored glue. This produces a product with the appearance of a textile product, where the embossing lines on the two outer plies simulate the weft and warp lines of the fabric, while the pattern printed on the inner sheet shines through the outer plies and simulates a decoration obtained by embroidery or the like on a woven product.

U.S. Pat. No. 6,221,211 describes a paper product with several plies, wherein the inner ply is provided with a printed decoration that shines through the outer layers. The main object of this decoration is to indicate the presence of particular ingredients in the products, which is indicated in particular for hygiene purposes such as facial cleansing and the like.

GB-A-2,255,745 describes a paper product in two plies, wherein the upper layer is embossed and glued with a colored glue to the second ply. A third outer ply, also embossed and glued to the intermediate ply, may also be provided.

GB-A-2,293,573 describes a sheet material particularly suitable to produce baby diapers. It comprises two layers coupled to each other, the outer layer of which is partially opaque and partially transparent. The second layer has a different coloring from the first layer and is visible therethrough at the level of the transparent areas. Decorative images are produced on the second layer.

EP-A-0684132 describes a multi-ply paper product and a respective production method. Two plies are glued together and subsequently embossed.

U.S. Pat. No. 5,339,730 describes a procedure to print and emboss a multiply web material. An ink is applied to the protuberances produced by embossing on one of the two plies, to produce a pattern that is visible through the second layer superimposed on and glued to the first.

U.S. Pat. No. 3,738,905 describes a method for producing an embossed web material, wherein two plies of tissue paper are embossed separately from each other by embossing rollers provided with linear ribbings. A product is obtained wherein the two plies are embossed according to lines inclined with respect to each other and inclined with respect to the machine direction, that is, with respect to the longitudinal edge of the web material obtained. The two plies are coupled to each other in the area in which the embossing line crosses over on the two plies.

GB-A-1,128,722 describes a web material decorated by a print visible through the outer paper ply, which is partially transparent.

As is apparent from the prior art documents referred to above, great efforts have been made by the manufacturers of this type of product to implement production methods that give rise to a product which is not only efficient from the functional viewpoint but also aesthetically pleasing.

### OBJECTS AND SUMMARY OF THE INVENTION

The object of the present invention is to implement a procedure to produce a product in sheet form, in particular made of multi-ply tissue paper, which has particular aesthetic and functional characteristics, superior to those of traditional products.

The object of the present invention is also to produce a product or multi-ply paper material of the aforesaid type, with particularly appreciable technical-functional and aesthetic characteristics.

Essentially, according to a first aspect the invention relates to a paper material in sheet form comprising at least a first ply and at least a second ply coupled to each other by means of a glue, wherein the first ply has embossing according to essentially continuous or discontinuous lines, that is, constituted by alignments of protuberances along at least a series of lines which are preferably inclined with respect to a longitudinal edge of the material and the second ply is printed with a decorative motif visible in transparency through the first ply. According to the invention, a product of this type (per se known from WO-A-03043812) is improved by the fact that the decorative pattern printed on the second ply is constituted by a design simulating a relief three-dimensional appearance, characterized by shading. For example, the decorative pattern may be the two-dimensional reproduction of embossing with shading simulating the three-dimensionality typical of embossing obtained by deformation of the web material by forming protuberances that project from the original plane of the ply.

The embossed ply, superimposed on the ply with the three-dimensional printing and through which said printing is visible in transparency, may be embossed with continuous or essentially continuous lines (preferably straight), in relief, or may be embossed according to discontinuous lines, that is alignments of individual protuberances, aligned at least according to lines, preferably straight and inclined with respect to the edge of the product.

Superimposition of the two plies thus produced and decorated gives rise to a product with a particularly pleasing appearance, as it simulates a woven fabric, especially when the embossing of the first ply is according to continuous straight lines, and at the same time gives the user the sensation of a three-dimensional product, that is, very thick and soft, due to the presence of the shaded decoration printed on the second ply.

According to a particularly advantageous embodiment of the invention, the paper material has a third ply coupled by means of a glue to the first two. The second printed ply is in this case interposed between the first and the third ply and its decoration is visible in transparency at least through the first ply and preferably also through the third ply. The third ply may also advantageously be embossed by means of essentially continuous and straight embossing lines, inclined with respect to a longitudinal edge of the Product. This second embossing is generally inclined with respect to the embossing of the first ply, preferably by 90°.

Rather than by essentially continuous lines, the embossing of the third 5 ply may be constituted by parallel alignments of individual protuberances, as may also be provided on the first ply. Said embossing may be constituted by geometrical microembossing according to alignments inclined with respect to the embossing lines of the first ply. The pitch of the protuberances on the single alignment may be equivalent to the pitch according to which the embossing lines or alignments of the protuberances of the first ply are disposed, or with a double or in general multiple pitch with respect to the pitch of the embossing or alignment lines of the embossings of the first ply. As shall be apparent from the description hereunder of some examples of embodiment, this allows the quantity of glue applied to the product to be reduced and thereby a product that is less expensive and above all softer and more pleasing to the touch, less stiff with respect to products obtainable by embossing of the third ply produced along continuous lines that receive glue along the full length of said lines.

In practice, embossing of the first ply may be constituted by lines or by alignments of protuberances that have a width ranging from 0.1 to 2 mm, more preferably from 0.1 and 1 mm and a density ranging from 1.5 and 20 lines per centimeter and preferably between 3 and 20 lines per centimeter. Similar dimensions may be provided for alignments of protuberances or for embossing lines of the third ply.

To obtain particular aesthetic effects, the glue used to couple the plies to one another may be a colored glue. The color of the glue and the color of the print produced on the second ply may be chosen so as to obtain particular optical effects. For example, in a possible embodiment the glue and the ink used to print the second ply are of the same color but different shades, for example, light pink and dark pink, or light red and dark red, or yet again light blue and deep blue or deep blue and dark blue and so:forth. The shades may be obtained with a different dilution of dye. In a variant of embodiment, the two colors are different primary colors, so that in the areas in which the glue and ink overlap the product adopts a third color constituted by the combination of two primary colors. For example, yellow and blue may be used as primary colors to obtain yellow, blue and green coloring in the finished product, the green being visible in the areas wherein the glue and the printing ink overlap.

The second ply which, in the preferred embodiment is interposed between the first and the third ply, may be embossed together with the third ply, passing the second and the third ply through a single embossing unit. Alternatively, the second ply may have a relief pattern obtained directly during the ply forming phase, by means of papermaker's fabrics with a particularly coarse grain and/or by means of a TAD drying system, known to those skilled in the art.

According to a different aspect, the invention relates to a method for producing a material of the aforesaid type according to claim 19. Particularly advantageous embodiments of the method according to the invention are indicated in the secondary claims.

### BRIEF DESCRIPTION OF THE DRAWINGS

The invention shall now be better understood according to the description and accompanying drawing which shows a series of non-limiting preferred embodiments of the invention. More specifically, in the drawings, in which identical or corresponding parts are indicated with the same reference numbers:

FIG. 1 shows a diagram of a system to implement the method according to the invention, in a first embodiment;

FIG. 2 shows a portion of the product obtainable with the system in FIG. 1 with parts removed;

FIGS. 3 and 4 show portions of the second ply with different printed motifs;

FIG. 5 shows a schematic and greatly enlarged section of the product obtained with the system in FIG. 1;

FIG. 6 again shows a greatly enlarged schematic plan view of a portion of the product in FIG. 5;

FIG. 7 shows, analogous to FIG. 1, a schematic side view of a system to implement the method of the invention, in a second embodiment;

FIG. 8 shows a greatly enlarged schematic section of a product obtained with the system in FIG. 7;

FIGS. 9, 10 and 11 show three diagrams of a system to implement three further embodiments of the method according to the invention; and

FIG. 12 shows a schematic plan view of a product according to another embodiment of the invention.

### DETAILED DESCRIPTION OF PREFERRED EMBODIMENTS OF THE INVENTION

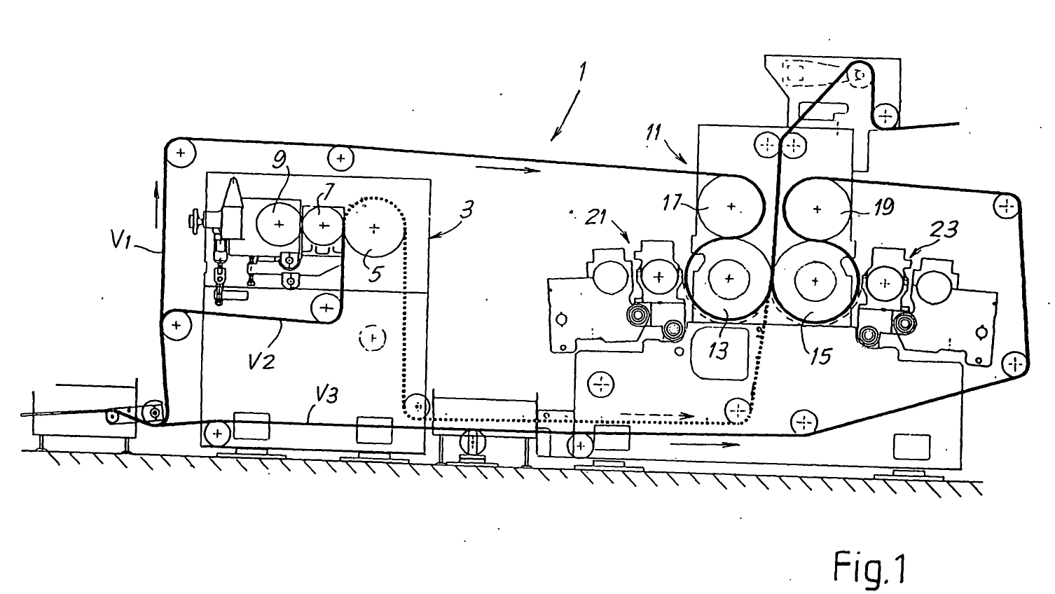

With initial reference to FIG. 1, a system to implement the method according to the invention, indicated as a whole with 1, comprises a printing unit 3 with a counter-pressure roller 5 and a cliche roller 7 which receives ink from an inking roller 9.

Disposed downstream of the printing unit 3 is an embossing-laminating unit 11. This comprises a first embossing cylinder 13 and a second embossing cylinder 15, both provided with protuberances with a form that will be described in greater detail hereunder. The embossing rollers 13 and 15 cooperate with respective pressure rollers 17 and 19 coated in rubber or another elastically yielding material. Respective glue dispensers 21 and 23 are associated with the two embossing rollers 13 and 15.

Three plies of paper material, in particular tissue paper, are fed to the system described summarily hereinbefore. More specifically, a first ply V1 is fed, by-passing the printing unit 3, directly to the embossing-laminating unit 11. This ply passes through the nip between the pressure roller. 17 and the embossing roller 13 and is embossed therein. Downstream of the nip the protuberances produced thereon are wetted with glue by the glue dispenser 21.

A second ply V2 passes through the printing unit 3 and is printed according to decorative patterns which shall be described hereunder in greater detail. It then passes directly through the nip defined between the embossing rollers 13 and 15.

A third ply V3 is fed directly to the embossing-laminating unit 11, bypassing the printing unit 3. It is driven around the pressure roller 19, passes through the nip between said pressure roller 19 and the embossing roller 15 and is embossed therein. Downstream of the nip between the rollers 15 and 19 the protuberances produced thereon receive a glue dispensed by the dispenser 23. The three plies V1, V2, V3 are then laminated together in the nip between the embossing rollers 13 and 15. Said embossing rollers are disposed with a distance between centers so that the protuberances provided on their surfaces press against each other at the level of the lamination nip between said rollers. This causes the three plies V1, V2 and V3 to adhere by gluing. The distance between the centers of the two rollers 13 and 15 is variable to modify the pressure with which they press against each other. It must be understood that, also as a function of the type of protuberances provided on the two embossing rollers, there may be exact reciprocal or casual correspondence between the protuberances of the two rollers in the lamination nip therebetween.

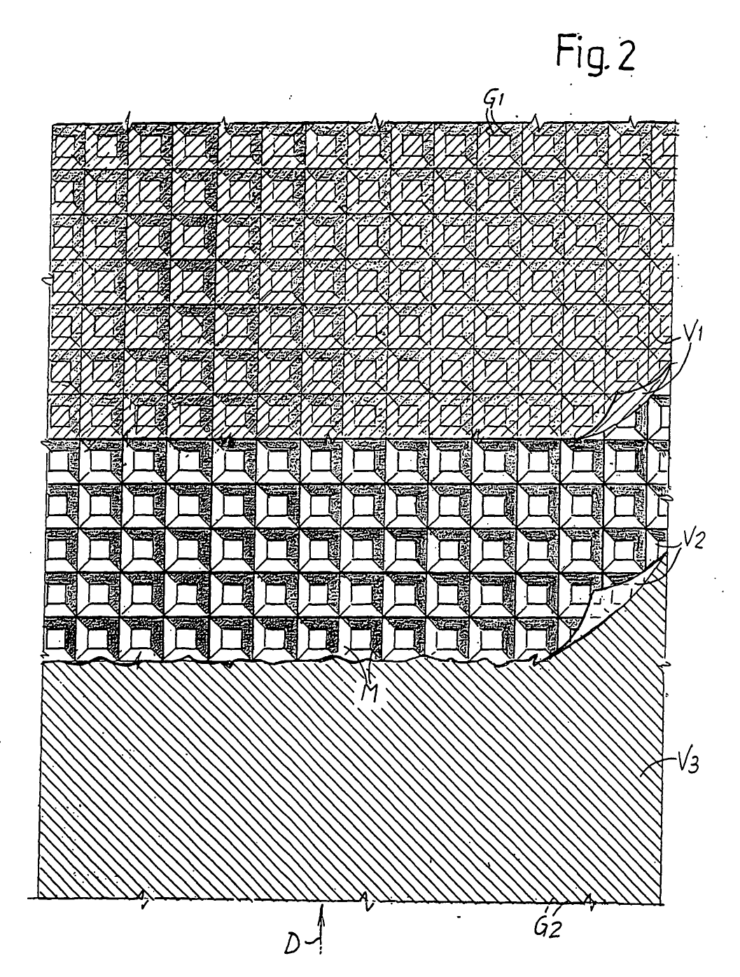

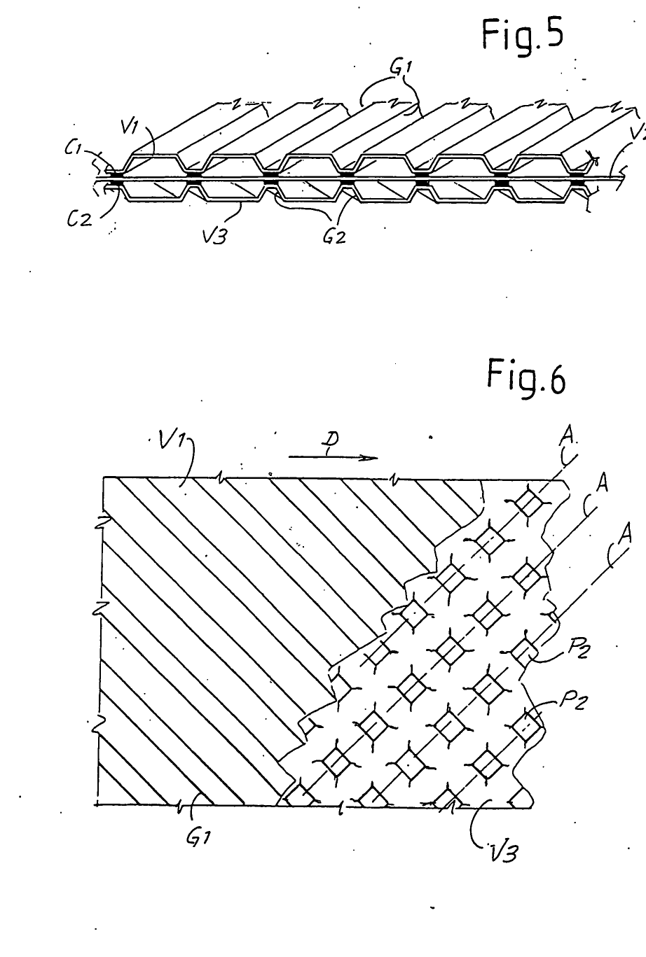

The configuration adopted by the three plies V1, V2 and V3 is shown in particular in FIGS. 2 and 5. The ply V1 is embossed by the embossing roller 13 in cooperation with the pressure roller 17 according to essentially straight embossing lines, indicated with G1, inclined (in the example shown) by about 45° with respect to the machine direction (arrow D) that is, with respect to the direction of feed of the ply V1 and hence with respect to its longitudinal edges. The embossing lines G1 are formed by protuberances in the form of linear helical ribbings produced on the surface of the roller 13.

The dimension and pitch of these lines is advantageously such that they efficaciously simulate the weft of a woven fabric, and typically the width of the embossing lines G1 ranges from 0.1 to 1 mm, while their density advantageously ranges from 3 to 20 lines per linear centimeter.

The ply V2 is essentially smooth, that is, not embossed, and provided with a printed design, which, in the example shown in FIG. 2, simulates three-dimensional embossing constituted by truncated-pyramid shaped protuberances. The three-dimensional effect, that is, the optical effect simulating the relief of the protuberances is obtained by shading the design.

The ply V3 is embossed according to essentially straight lines of embossing G2 constituted, analogous to the lines G1, by protuberances facing the inside of the multi-ply product obtained by the assembly of the three plies V1, V2 and V3. In the example shown, the protuberances or embossing lines G2 have a dimension and density essentially equivalent to those of the embossing lines G1, but are turned through 90° with respect to the latter. However, this is not binding. The dimensions, density and direction of the protuberances of the third ply may even be essentially different from those indicated above.

As can be seen in FIG. 5, the plies V1 and V3 are glued by means if a glue C1 and a glue C2 to the intermediate ply V2. The glue C1 is applied by the dispenser 21, while the glue C2 is applied by the dispenser C2. The glue is distributed on the front surfaces of the embossing lines or protuberances G1 and G2 when these are still engaged with the corresponding protuberances of the embossing rollers 13 and 15 which produced them.

The decorative pattern M printed on the ply V2 with the shadings simulating the three-dimensionality of the design is printed with ink, the color of which is chosen to give a particular optical effect in combination with the color of the glue C1 and/or C2. In fact, one or other or both the glues C1, C2 dispensed by the dispensers 21, 23, may be colored. For example, the ink with which the decorative patterns M are printed and the glue or glues C1, C2 may have two shades of the same base color, or may be two primary colors which when combined by superimposition give rise to a third color (i.e. yellow, blue and green).

The overall effect which is obtained is that of a particular soft and thick product with a textile appearance. The production of a printed motif simulating a relief decoration, which constitutes an essential characteristic of the present invention, gives the product a particularly pleasing aesthetic appearance due to the fact that the user perceives the material as if it were much thicker and softer than it actually is and as if it were provided with marked embossing according to the decorative pattern M.

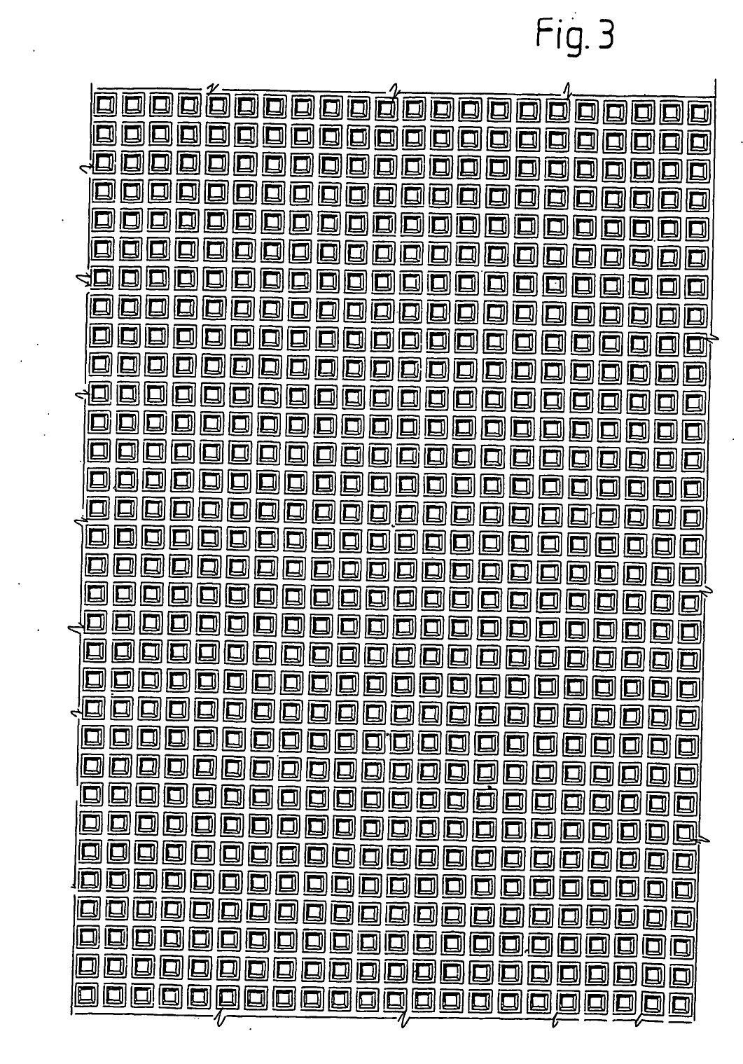

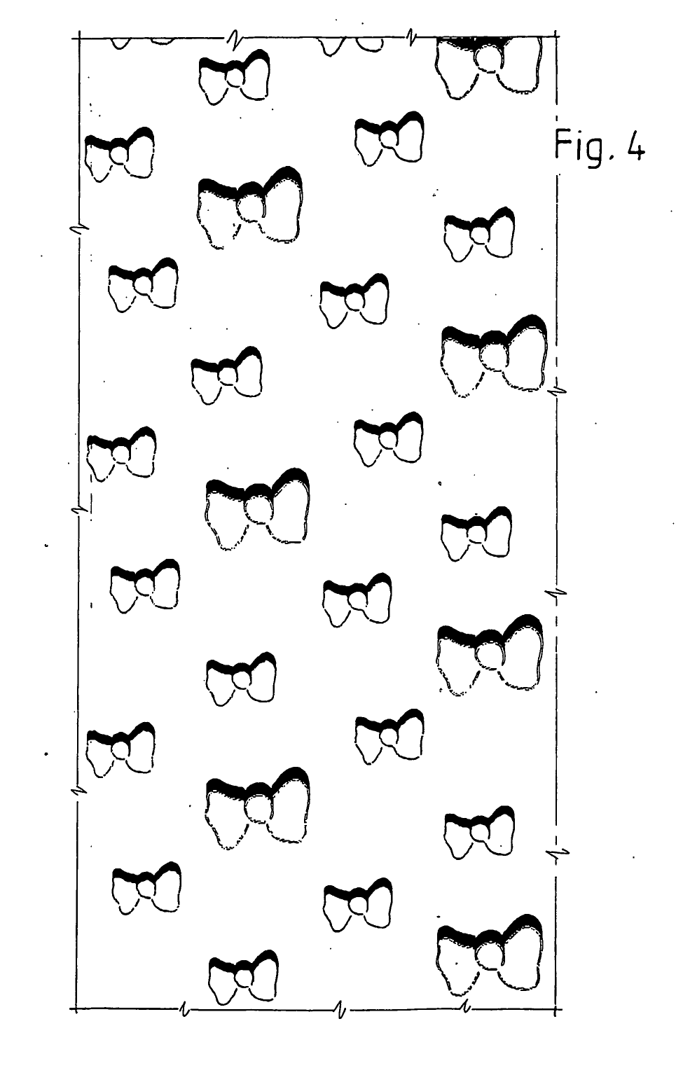

FIGS. 3 and 4 show decorative patterns simulating a three-dimensionality or relief that may be used alternatively to the pattern M shown in FIG. 2 to decorate the intermediate ply V2 of the product. In general, the decorative patterns may be of the geometric and repetitive type, or may be a famcy pattern, or also a combination thereof. They may also be printed in different colors and/or shades and/or characterized by double shading, to simulate double height embossing.

To reduce the quantity of glue applied to the material and thereby make it softer and more flexible, the ply V3 may be embossed according to individual protuberances aligned according to inclined alignments, rather than be embossed according to continuous embossing lines G3. This solution is illustrated schematically in FIG. 6, where in a plan view the two outer plies V1 and V3 are shown, while the intermediate ply is omitted for clarity of representation. The ply V1 is once again embossed according to embossing lines G1 inclined with respect to the machine direction D, that is, with respect to a longitudinal edge of the product. However, the underlying outer ply V3 (visible in the area in which the ply V1 and the ply V2 have been removed) has embossing constituted by a series of protuberances P2 with a geometrical form (such as a truncated-pyramid) aligned according to alignments A parallel with one another and turned (in the example shown) through 90° with respect to the embossing line G1 of the ply V1. The protuberances P2 may also be aligned according to other alignments, besides the one identified by the lines A. One of these alignments may be parallel to the embossing lines G1 of the first ply.

The glue C applied by the dispenser 23 is therefore distributed on a surface, represented by the front surface of the protuberances P2, to a much lesser extent to the product in FIG. 5, wherein the embossing lines G2 are continuous. The layout of the alignments A may be according to a pitch essentially equivalent to that of the embossing lines G1, while the pitch of the protuberances P2 along each single alignment may be the same as the pitch of the embossing lines G1 or also even half or another multiple or submultiple thereof.

By reducing the number of the protuberances P2, for example increasing their pitch along the alignments A, or also increasing the pitch between contiguous alignments A, the quantity of glue applied between the ply V2 and the ply V3 may be greatly reduced. The exterior appearance deriving from a lesser aesthetic value of the product on the face whereon the ply V3 is visible is not particularly important. In fact, this sheet material is destined in particular to produce products in rolls, such as toilet paper or the like. In these products importance is given above all the aesthetic appearance of the visible face of the material, represented in this case by the outer surface of the upper ply V1. Visible through this is the underlying printed decoration M produced on the intermediate ply V2, which is superimposed on and combined with the aesthetic effect provided by the glue C1 applied, on the embossing lines G1. The aesthetic characteristic of the back face of the product, defined by the outer surface of the underlying ply V3, is much less important. Said ply V3 may even by produce with white paper, while the ply V1 may be produced with colored paper; moreover, the glue C2 may also be white and not colored as instead the glue C1 is.

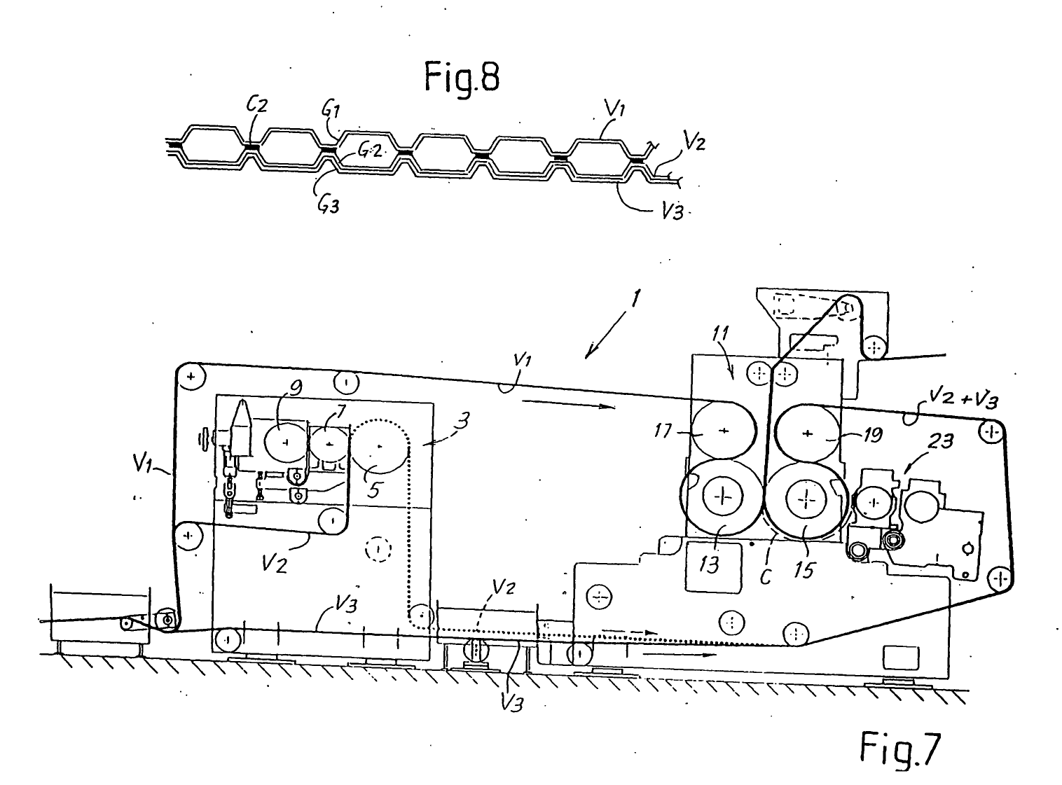

FIG. 7 shows, schematically and analogous to FIG. 1, a different configuration of a system, indicated once again with 1, for producing material according to the invention. The same numbers indicate parts identical or corresponding to those of the system in FIG. 1. The system in FIG. 7 differs from the system in FIG. 1 essentially due to the fact that a single glue dispenser 23, cooperating with the embossing roller 15, is associated with the embossing-laminating unit 11, while the embossing roller 13 has no glue dispenser.

Moreover, the path of the ply V2 is modified with respect to that of the system in FIG. 1. In fact, in this embodiment the ply V2, after having been printed, is combined with the ply V3 before being fed to the embossing-laminating roller 11. The plies V2 and V3 are then fed together into the embossing nip defined between the embossing roller 15 and the pressure roller 19. These plies are embossed together with an embossing pattern defined by the protuberances provided on the embossing roller 15. For example, they may be embossed according to embossing lines G2 (FIG. 5) or according to isolated embossing protuberances like the protuberances P2 (FIG. 6). The ply V1 is instead fed, as in the case in FIG. 1, through the embossing nip defined between the pressure roller 17 and the embossing roller 13.

The product that is obtained is represented somewhat schematically in FIG. 8. The plies V2 and V3 have linear embossing protuberances G3 and G2 which are nested inside one another. The glue C2 dispensed by the dispenser 23 is applied to the front surface of the embossing protuberances G3 formed on the ply V2. In the lamination nip between the embossing rollers 13 and 15 the glue—besides coupling the plies V1 and V2—leaks through the fibers forming the ply V2 in a quantity sufficient to guarantee reciprocal bonding between the plies V2 and V3.

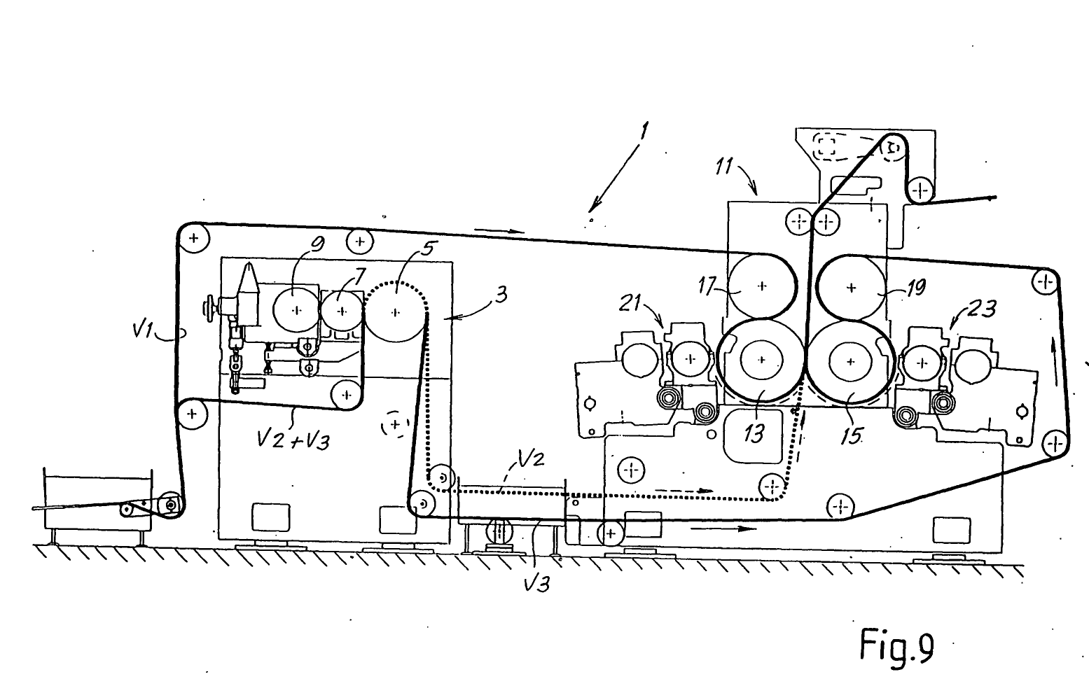

FIG. 9 shows a further configuration of the system to implement the method in a different embodiment. The same numbers indicate, parts identical or corresponding to those of the system shown in FIG. 1.

The system differs from the system in FIG. 1 due to the fact that the plies V2 and V3 are fed together through the printing unit 3 and are separated downstream thereof to be fed one through the lamination nip between the rollers 13 and 15 while the other is first fed through the embossing roller between the rollers 19 and 15 and subsequently through the lamination nip between the rollers 13 and 15. The product that is obtained is essentially equivalent to the one shown in FIG. 5 or in FIG. 6.

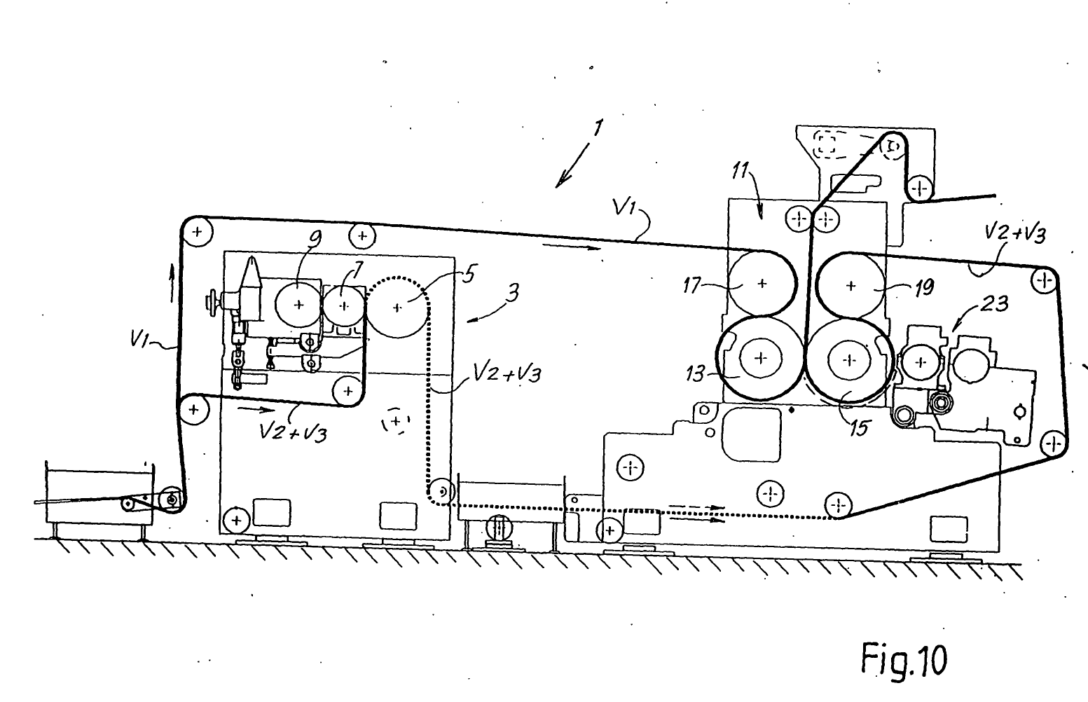

FIG. 10 shows a modified embodiment of the system to implement the method according to the invention. Also in this case the same numbers indicate parts identical or equivalent to those of the example shown in FIG. 1.

The system in FIG. 10 differs from the system in FIG. 1 due to the fact that the plies V2 and V3 are fed in parallel through the printing unit 3 and also through the embossing nip between the rollers 15 and 19. They are thus embossed together as in the example in FIG. 7. The material obtained is therefore analogous to the one shown in FIG. 8. The glue is dispensed from a single dispenser 23, contrary to the system in FIG. 1, said dispenser being combined With the embossing roller 15.

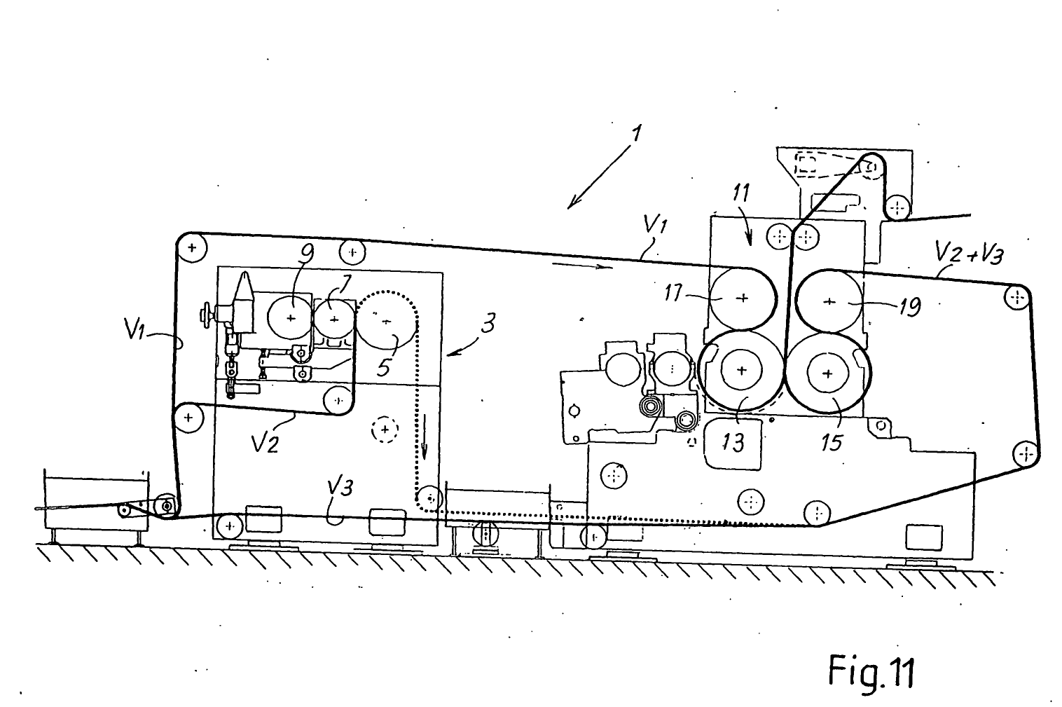

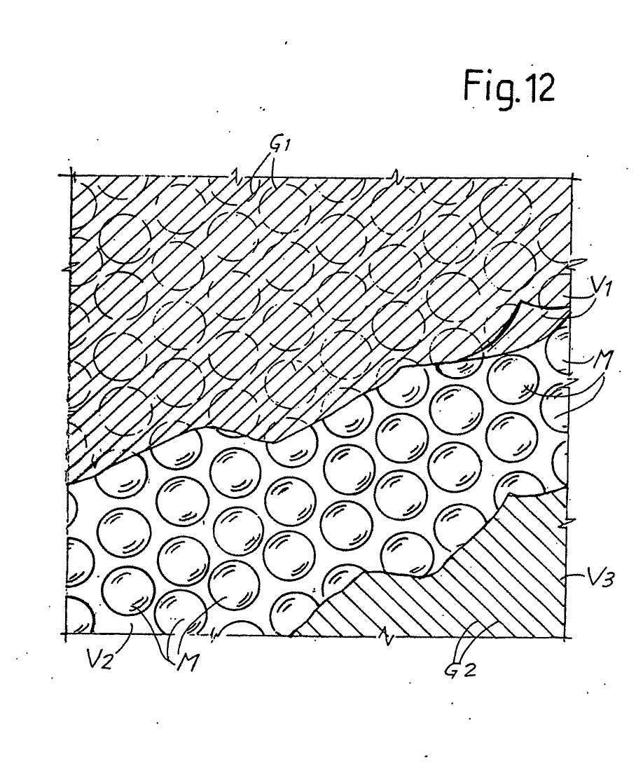

Finally, FIG. 11 shows yet another configuration of the system to implement the method according to the invention. The same numbers indicate parts identical or equivalent to those in the previous embodiments. Once printed the ply V2 is combined with the ply V3 and the two plies V2 and V3 are fed through the embossing nip between the pressure roller 19 and the embossing roller 15 to be embossed together and thus obtain, after lamination with the previously embossed ply V1, a material with a structure equivalent to the one shown in FIG. 8. A single glue dispenser 21 is associated with the embossing-laminating unit 11, cooperating in this case with the embossing roller 13.

The product produced according to the present invention, besides the advantages mentioned above, also has the advantage of keeping the colored glue and/or printing ink confined inside the product, while the outer plies V1 and V3 may be free of ink. This avoids contamination towards the outside, a particularly important characteristic when the product is destined to come into contact with the body. Moreover, the fact that the outer plies are white allows a noteworthy reduction in costs. Therefore, they seem colored by the effect of the internal ink and the colored glue, without having the drawbacks of colored plies.

In the examples shown, the ply V2 is printed on the face facing the ply V1 which, in the finished product (for example a product in roll form) constitutes the outer ply. Nonetheless, it would also be possible to print the opposite face.

Although in the examples illustrated the product is always constituted by three plies, it must be understood that certain advantages of the present invention are also obtained with the use of only two plies, or that the products may be formed or more than three plies, that is one or other of the plies V1, V2 and V3 may be constituted in turn by more than one layer. The configurations illustrated in FIGS. 1, 7, 9, 10 and 11, in particular, may be adopted to produce a product formed of only two plies. In the configurations in FIGS. 1 and 9 the ply V2 remains unembossed, while in the configurations in FIGS. 7, 10 and 11 the ply V2 is embossed.

It is understood that the drawing purely shows an example provided solely as a practical layout of the invention, which may vary in forms and layouts without however departing from the scope of the concept on which the invention is based.

1-38. (canceled)

39. A sheet of paper material comprising at least a first ply and a second ply, coupled to each other by means of a glue, wherein said first ply has a first embossing in a direction according to at least one alignment, and the second ply is printed with a decorative pattern, wherein the decorative pattern has shading simulating a relief three-dimensional design.

40. Material as claimed in claim 39, wherein said alignment is inclined with respect to a longitudinal edge of said material.

41. Material as claimed in claim 39, wherein said first ply is embossed according to essentially continuous embossing lines.

42. Material as claimed in claim 40, wherein said first ply is embossed according to essentially continuous embossing lines.

43. Material as claimed in claim 41, wherein the embossing lines of the first ply are essentially straight.

44. Material as claimed in claim 39, wherein said decorative pattern simulates an embossing.

45. Material as claimed in claim 40, wherein said decorative pattern simulates an embossing.

46. Material as claimed in claim 41, wherein said decorative pattern simulates an embossing.

47. Material as claimed in claim 39, further comprising a third ply coupled by glue to said first ply and to said second ply, said second ply being interposed between the first ply and the third ply.

48. Material as claimed in claim 47, wherein said third ply has a second embossing disposed according to a direction inclined with respect to a longitudinal edge of the material and not parallel to lines of said first embossing on the first ply.

49. Material as claimed in claim 48, wherein said second embossing is constituted by essentially continuous lines.

50. Material as claimed in claim 48, wherein said second embossing is constituted by alignments parallel with one another, and inclined with respect to said longitudinal edge, of essentially geometrical protuberances.

51. Material as claimed in claim 50, wherein said essentially geometric protuberances have along said alignments a pitch substantially the same as a pitch of said lines forming the first embossing or a multiple or submultiple of said pitch.

52. Material as claimed in claim 39, wherein lines of the first embossing have a width ranging from 0.1 to 2 mm and a density ranging from 1.5 and 20 lines per cm.

53. Material as claimed in claim 49, wherein said essentially continuous lines forming the second embossing have a width ranging from 0.1 to 2 mm and a density ranging from 1.5 to 20 lines per cm.

54. Material as claimed in claim 52, wherein said second ply includes a second embossing constituted by essentially continuous lines and said essentially continuous lines forming the second embossing have a width ranging from 0.1 to 2 mm and a density ranging from 1.5 to 20 lines per cm.

55. Material as claimed in claim 50, wherein said parallel alignments forming the second embossing have a density ranging from 1.5 to 20 alignments per cm.

56. Material as claimed in claim 39, wherein said glue is colored.

57. Material as claimed in claim 56, wherein said decorative pattern has a color essentially the same as the color of said glue.

58. Material as claimed in claim 56, wherein said decorative pattern has a different shade of color from the color of said glue.

59. Material as claimed in claim 56, wherein said decorative pattern has a first primary color and said glue has a second primary color, the material having a color obtained by combining said first primary color and said second primary color in areas in which the decorative pattern and the glue are superimposed.

60. Material as claimed in claim 47, wherein said second ply and said third ply are embossed together.

61. A method to produce a web paper material comprising at least a first ply and a second ply coupled to each other by a glue, wherein said first ply is embossed according to a first embossing along at least one alignment, and the second ply is printed with a decorative pattern, and wherein the decorative pattern has shading simulating a relief three-dimensional design.

62. Method as claimed in claim 61, wherein said alignment is inclined with respect to a longitudinal edge of said material.

63. Method as claimed in claim 62, wherein said first ply is embossed according to essentially continuous lines.

64. Method as claimed in claim 63, wherein said lines are essentially straight.

65. Method as claimed in claim 62, wherein said decorative pattern simulates an embossing.

66. Method as claimed in claim 63, wherein said decorative pattern simulates an embossing.

67. Method as claimed in claim 64, wherein said decorative pattern simulates an embossing.

68. Method as claimed in claim 62, further comprising a third ply coupled by glue to said first ply and to said second ply, said second ply being interposed between the first ply and the third ply.

69. Material as claimed in claim 68, wherein said third ply is embossed according to a second embossing disposed according to a direction inclined with respect to the longitudinal edge of the material and not parallel to lines of said first embossing on the first ply.

70. Method as claimed in claim 69, wherein said second embossing is constituted by essentially continuous lines.

71. Method as claimed in claim 69, wherein said second embossing is constituted by alignments parallel with one another and inclined with respect to said longitudinal edge, of essentially geometrical protuberances.

72. Method as claimed in claim 71, wherein said essentially geometrical protuberances have along said alignments a pitch substantially the same as a pitch of said lines forming the first embossing or a multiple or submultiple of said pitch.

73. Method as claimed in claim 62, wherein lines of the first embossing have a width ranging from 0.1 to 2 mm and a density ranging from 1.5 and 20 lines per cm.

74. Method as claimed in claim 70, wherein said essentially continuous lines forming the second embossing have a width ranging from 0.1 to 2 mm and a density ranging from 1.5 to 20 lines per cm.

75. Method as claimed in claim 73, wherein said second ply includes a second embossing constituted by essentially continuous lines and said essentially continuous lines forming the second embossing have a width ranging from 0.1 to 2 mm and a density ranging from 1.5 to 20 lines per cm.

76. Method as claimed in claim 71, wherein said parallel alignments forming the second embossing have a density ranging from 1.5 to 20 alignments per cm.

77. Method as claimed in claim 62, wherein said glue is colored.

78. Method as claimed in claim 77, wherein said decorative pattern has a color essentially the same as the color of said glue.

79. Method as claimed in claim 77, wherein said decorative pattern has a different shade of color from the color of said glue.

80. Method as claimed in claim 77, wherein said decorative pattern has a first primary color and said glue has a second primary color, the material having a color obtained by combining said first primary color and said second primary color in areas in which the decorative pattern and the glue are superimposed.

81. Method as claimed in claim 68, wherein said second ply and said third ply are embossed together.
